(19) United States
(12) Patent Application Publication
(10) Pub. No.: US 2026/0196603 A1
(43) Pub. Date: Jul. 9, 2026

(54) IMMERSION COOLING MODULE

(71) Applicants: SK INNOVATION CO., LTD., Seoul (KR); SK On Co., Ltd., Seoul (KR)

(72) Inventors: In Sik JUNG, Daejeon (KR); Gi Hong MIN, Daejeon (KR)

(21) Appl. No.: 19/438,630

(22) Filed: Jan. 1, 2026

(30) Foreign Application Priority Data
Jan. 6, 2025 (KR) 10-2025-0001760

(51) Int. Cl. H01M 10/6567; H01M 10/613; H01M 10/6551

(52) U.S. Cl. CPC H01M 10/6567; H01M 10/613; H01M 10/6551

(57) ABSTRACT

Proposed is an immersion cooling module including a housing in which an inlet for cooling fluid to flow in and an outlet for cooling fluid to flow out are formed, and in which the cooling fluid is accommodated at a predetermined level to form an upper space, a cooling chamber coupled to a lower end of the housing, and configured to have a chamber inlet through which the cooling fluid flows in and a chamber outlet through which the cooling fluid is discharged, battery cells spaced apart from each other and immersed in the cooling fluid, and cooling fluid passage parts respectively formed in cooling spaces divided by the battery cells, wherein heat transfer members are arranged at predetermined intervals in a direction perpendicular to a flow direction of the cooling fluid.

### CROSS REFERENCE TO RELATED APPLICATION

The present application claims priority to Korean Patent Application No. 10-2025-0001760, filed on January 6, 2025, the entire contents of which are incorporated by reference herein for all purposes.

### BACKGROUND

### Technical Field

The embodiments of the present disclosure relate generally to an immersion cooling module.

### Description of Related Art

In recent years, as mobile devices such as mobile phones and laptops have become smaller and lighter, and electric vehicles and hybrid vehicles demand high-capacity power sources, a variety of batteries are being developed and used.

In the case of secondary batteries, efficiency is becoming increasingly important depending on the application field, but problems such as heat generation and fires during charging or operation occur due to external factors.

Accordingly, technologies are being developed to increase the operating efficiency of secondary batteries and ensure safety. Moreover, a recent surge in electricity usage has led to increased carbon emissions and exacerbated global warming concerns, which has called for more efficient device operation mechanisms, and improved cooling methods and maximization of cooling efficiency therefor.

### SUMMARY

An embodiment of the present disclosure, provides an immersion cooling module that mitigates the decrease in cooling efficiency of a cooling fluid during the flow of the cooling fluid within a housing, thereby maximizing the cooling efficiency of a battery cell by the cooling fluid.

Another embodiment of the present disclosure provides an immersion cooling module that increases cooling efficiency of the entire interior of a housing by a cooling fluid by appropriately controlling the flow amount and flow speed according to the flow direction and location of the cooling fluid within the housing.

To achieve the above objectives, an embodiment of the present disclosure provides an immersion cooling module including a housing in which an inlet for cooling fluid to flow in and an outlet for cooling fluid to flow out are formed, and in which the cooling fluid is accommodated at a predetermined level to form an upper space; a cooling chamber coupled to a lower end of the housing, and configured to have a chamber inlet through which the cooling fluid flows in and a chamber outlet through which the cooling fluid is discharged; battery cells spaced apart from each other and immersed in the cooling fluid; and cooling fluid passage parts respectively formed in cooling spaces divided by the battery cells, wherein heat transfer members are arranged at predetermined intervals in a direction perpendicular to a flow direction of the cooling fluid, and wherein each of the heat transfer members may be formed such that a portion of a first side thereof is accommodated in the cooling chamber and a portion of a second side thereof is exposed to the upper space of the housing.

In an embodiment, the heat transfer member may be formed in a cylindrical shape, and the predetermined intervals of the heat transfer members in the cooling fluid passage parts may gradually decrease from the inlet toward the outlet of the housing.

In an embodiment, the module may further include an upper inlet formed on a first side of the upper space of the housing; and an upper outlet formed on a second side of the upper space of the housing, wherein as a cooling gas flows from the upper inlet to the upper outlet of the upper space of the housing, a second end of the heat transfer member is cooled.

In an embodiment, the cooling fluid passage parts may be formed in spaces partitioned by the battery cells from the inlet of the housing into a first cooling fluid passage part, a second cooling fluid passage part, and a third cooling fluid passage part, wherein when a spacing between the heat transfer members in the first cooling fluid passage part is denoted as a, a spacing between the heat transfer members in the second cooling fluid passage part is denoted as b, and a spacing between the heat transfer members in the third cooling fluid passage part is denoted as c, sizes of the spacings may satisfy a> b> c.

In an embodiment, each of the cooling fluid passage parts may be composed of a plurality of heat transfer members, and a diameter of the heat transfer member at each end of the cooling fluid passage part may be formed to be larger than a diameter of the heat transfer member at the center of the cooling fluid passage part.

In an embodiment, each of the cooling fluid passage parts may be composed of a plurality of heat transfer members, and a spacing between the heat transfer members at each end of the cooling fluid passage part may be formed narrower than a spacing between the heat transfer members at the center of the cooling fluid passage part.

In an embodiment, each of the cooling fluid passage parts may be formed with a plurality of heat transfer members spaced apart at predetermined intervals, and a spacing between the heat transfer members arranged on a surface facing one side of each of the battery cells may be formed to be wider than a spacing between the heat transfer members arranged on a surface not facing each of the battery cells.

In an embodiment, the chamber inlet of the cooling chamber may be provided on a lower surface of the housing adjacent to the inlet of the housing, so that a cooling fluid flowing into the inlet may flow into the cooling chamber.

The features and advantages of the embodiments of the present disclosure will become more apparent from the following detailed description based on the accompanying drawings.

Another embodiment of the present disclosure provides an immersion cooling module including a housing including an inlet for cooling fluid to flow in and an outlet for cooling fluid to flow out, a cooling chamber coupled to a lower side of the housing and configured to have a chamber inlet through which the cooling fluid flows from the housing into the cooling chamber and a chamber outlet through which the cooling fluid is discharged, wherein the housing and the cooling chamber provide separate paths for the cooling fluid, battery cells and cooling fluid passage parts spaced apart from each other in an alternating manner, wherein the battery cells are immersed in the cooling fluid inside the housing with a portion of each battery cell extending above the cooling fluid to a gas cooling space of the housing, wherein each cooling fluid passage part includes a plurality of heat transfer members spaced apart from each other at a predetermined gap, and wherein each of the heat transfer members extends both in the housing and in the cooling chamber.

It is noted a that terms or words used in this specification and claims should not be construed in their usual, dictionary meaning, and should be interpreted with meaning and concept consistent with the technical ideas of the present disclosure based on the principle that the inventor can define terminology appropriately to describe his or her invention in the best way possible.

According to an embodiment of the present disclosure, the cooling performance of a cooling fluid can be improved depending on the flow direction and location of the cooling fluid within the housing.

Furthermore, since a cooling fluid itself can be cooled in the flow direction of the cooling fluid within the housing, deterioration of cooling performance associated with the flow of the cooling fluid can be minimized, and thus the efficiency of battery cell cooling by the cooling fluid can be maximized.

Furthermore, by improving the cooling efficiency of battery cells within the housing, the operating performance and efficiency of devices employing the battery cells can be effectively enhanced, thereby contributing to a reduction in carbon emissions.

### BRIEF DESCRIPTION OF THE DRAWINGS

The above and other objectives, features, and advantages of the embodiments of the present disclosure will be more clearly understood from the following detailed description when taken in conjunction with the accompanying drawings, in which:

FIG. 1 is a side schematic view of an immersion cooling module according to an embodiment of the present disclosure;

FIG. 2 is a plan schematic view of an immersion cooling module according to an embodiment of the present disclosure;

FIG. 3 is a plan schematic view of an immersion cooling module according to a modified embodiment of the present disclosure; and

FIG. 4 is a plan schematic view of an immersion cooling module according to another modified embodiment of the present disclosure.

### DETAILED DESCRIPTION

Terms used to describe an embodiment of the present disclosure are not intended to limit the embodiments. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this disclosure, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

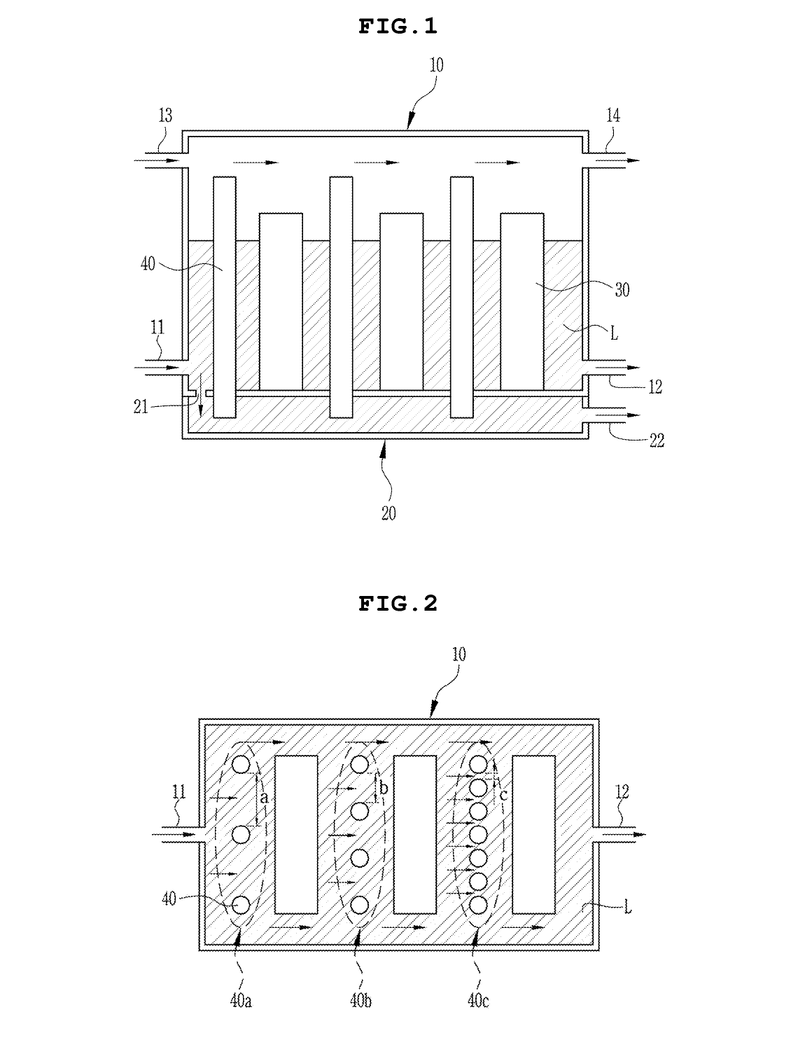

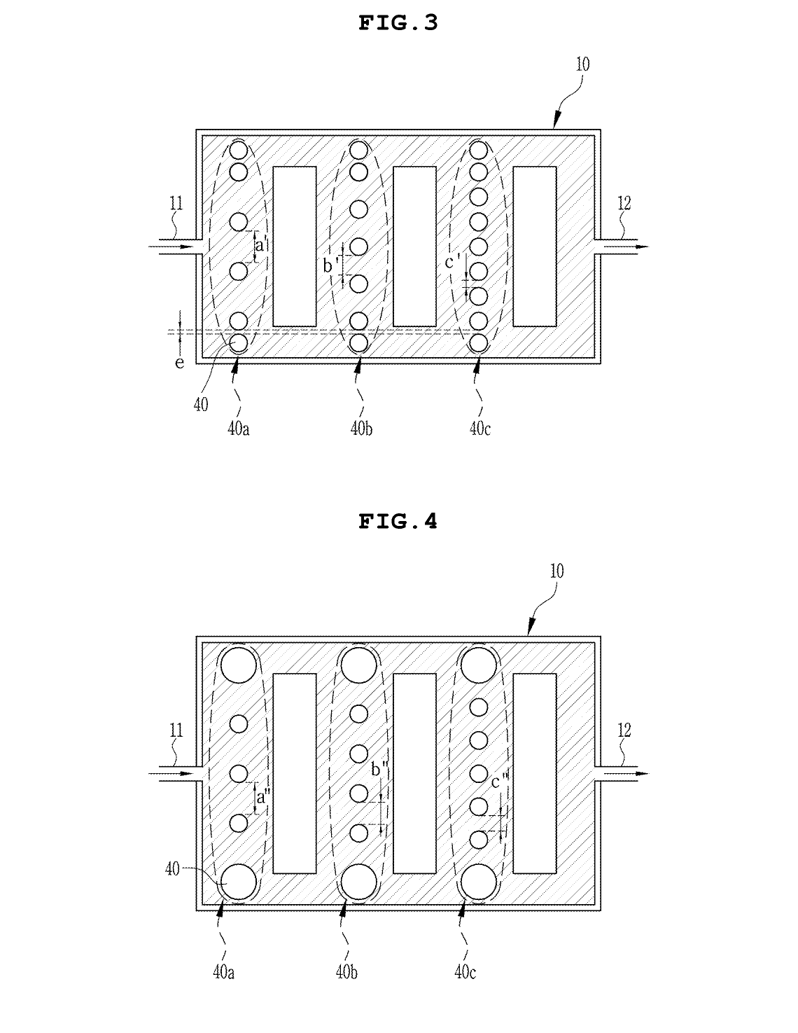

FIG. 1 is a side schematic view of an immersion cooling module according to an embodiment of the present disclosure; FIG. 2 is a plan schematic view of an immersion cooling module according to an embodiment of the present disclosure; FIG. 3 is a plan schematic view of an immersion cooling module according to a modified embodiment of the present disclosure; and FIG. 4 is a plan schematic view of an immersion cooling module according to another modified embodiment of the present disclosure.

An immersion cooling module according to an embodiment of the present disclosure may include a housing 10 including an inlet 11 for cooling fluid to flow in and an outlet 12 for cooling fluid to flow out and in which the cooling fluid is accommodated at a predetermined level to form an upper space; a cooling chamber 20 coupled to the lower end of the housing 10, and having a chamber inlet 21 through which the cooling fluid flows in and a chamber outlet 22 through which the cooling fluid is discharged; a plurality of battery cells 30 spaced apart from each other and immersed in the cooling fluid; and cooling fluid passage parts respectively formed in cooling spaces divided by the battery cells 30, wherein heat transfer members 40 are arranged at predetermined intervals in a direction perpendicular to the flow direction of the cooling fluid. The plurality of heat transfer members 40 may be formed such that a portion of one side is accommodated in the cooling chamber 20 and a portion of the other side is exposed to the upper space of the housing 10.

As shown in FIG. 1, the housing 10 may accommodate a cooling fluid (indicated by the shading) at a predetermined level. The cooling fluid may be contained in the housing 10 at a level that leaves a predetermined space in the upper portion of the interior of the housing 10. For example, as shown in FIG. 1, an upper part of the battery cells 30 and an upper part of the heat transfer members 40 may be positioned above the level of the cooling fluid inside the housing 10. The cooling fluid may completely fill the cooling chamber 20.

The cooling chamber 20 may be coupled to the lower end of the housing 10, or may be integrally formed with the housing 10 such that an internal space is separately defined.

The cooling chamber 20 may be formed to be coupled to the lower surface of the housing 10 so that the cooling fluid flows separately, and may have the chamber inlet 21 through which cooling fluid flowing into the housing 10 flows in and the chamber outlet 22 through which cooling fluid flowing out of the cooling chamber 20 flows out. The cooling chamber 20 provides an additional distinct flow path for the cooling fluid.

The battery cells 30 may be immersed in a cooling fluid contained within the housing 10. The battery cells 30 are cooled by being immersed in the cooling fluid, and the plurality of battery cells 30 may be arranged at predetermined intervals. The gap spaces between the battery cells 30 may be configured to form a plurality of cooling spaces, each divided along the flow direction of the cooling fluid within the housing 10.

That is, as shown in FIG. 1, the cooling spaces created by the gaps between the battery cells 30 may be sequentially formed along the direction in which the cooling fluid flows from the inlet 11 to the outlet 12 of the housing 10.

Within the cooling spaces defined by the battery cells 30, the heat transfer members 40 may be disposed at predetermined intervals along a plane perpendicular to the flow direction of the cooling fluid. By arranging the heat transfer members 40 in a direction perpendicular to the flow direction of the cooling fluid, the cooling fluid flows through the gaps between the heat transfer members 40. A cooling fluid passage part refers to the regions including the plurality of heat transfer members 40 disposed in a cooling space created by the spaced-apart heat transfer members 40.

That is, the cooling fluid passage part is configured on a plane perpendicular to the direction of cooling fluid flow, and as the cooling fluid flows through the spaces between the heat transfer members 40 disposed in the cooling fluid passage part, the cooling fluid itself may be cooled by means of the heat transfer members 40 while flowing in direct contact with the heat transfer members 40 as described later.

Thus, a portion of one end of the heat transfer member 40 is submerged in the cooling chamber 20 described above and cooled, while a portion of the other end of the heat transfer member 40 is immersed in the cooling fluid inside the housing 10 and exposed to the upper space of the housing 10, allowing the heat transfer member 40 to be further cooled by a cooling gas flowing through the upper space of the housing 10. In addition, in the central portion of the heat transfer member 40, the cooling fluid is cooled through direct contact with the heat transfer member 40.

An upper inlet 13 is formed on one side of the upper space inside the housing 10 and an upper outlet 14 is formed on the other side of the upper space inside the housing 10, and a cooling gas flows into the upper inlet 13 and flows toward the upper outlet 14, so that the other end of the heat transfer member 40 may be cooled.

As shown in FIG. 2, the heat transfer member 40 may be formed in a cylindrical shape. By being formed in a cylindrical shape, the contact area with the cooling fluid may be maximized and the resistance to the flow of the cooling fluid may be minimized.

As shown in FIG. 2, the cooling fluid passage parts may be formed sequentially in the flow direction of the cooling fluid within the housing 10. In an embodiment, like the one illustrated in FIG. 2, a predetermined interval or gap between adjacent heat transfer members 40 in each of the cooling fluid passage parts (40a, 40b, and 40c) may become narrower in the direction of the cooling fluid flow.

For example, as shown in FIG. 2, the gap between the heat transfer members 40 of the first cooling fluid passage part 40a through which a cooling fluid flows when the cooling fluid enters the inlet 11 of the housing 10 may be denoted as a, the gap between the heat transfer members 40 of the second cooling fluid passage part 40b may be denoted as b, and the gap between the heat transfer members 40 of the third cooling fluid passage part 40c may be denoted as c, and the width of the gaps gradually narrows, i.e., a > b > c.

By narrowing the gap width in the direction in which the cooling fluid flows, the flow rate of the cooling fluid passing through each cooling fluid passage may be controlled to increase gradually under the same flow amount and fluid pressure. By doing so, it is possible to minimize the decrease in cooling performance of the cooling fluid from the inlet 11 to the outlet 12 within the housing 10.

In this way, by adjusting the spacing between the heat transfer members 40 of the cooling fluid passage parts, the flow speed of the cooling fluid in each cooling space may be effectively controlled, thereby preventing deterioration of cooling performance of the cooling fluid, and effectively improving the cooling performance.

In addition, as previously described, by cooling one end and the other end of the heat transfer member 40 that come into contact with a cooling fluid while the cooling fluid flows separately utilizing the cooling chamber 20 and the upper space inside the housing 10, the cooling fluid itself may be cooled again by means of the heat transfer member 40, thereby improving the cooling performance of the cooling fluid.

As shown in FIG. 3, at least one of the cooling fluid passage parts may be composed of a plurality of heat transfer members 40, and the gap between the heat transfer members 40 at opposite ends of each of the cooling fluid passage parts may be formed to be narrower than the gap between the heat transfer members 40 at the center of the cooling fluid passage part. For example, the first cooling fluid passage part 40a may be composed of six heat transfer members 40, and the gap between the heat transfer members 40 at opposite ends of each of the first cooling fluid passage part 40a may be formed to be narrower than the gap between the heat transfer members 40 at the center of the first cooling fluid passage part 40a.

That is, as shown, the spacing of the heat transfer members 40 located near opposite ends of the battery cell 30, or in regions beyond opposite ends of the battery cell 30, may be made narrower than the spacing of the heat transfer members 40 in the direction in which the cooling fluid flows along one side of the battery cell 30. By doing so, the cooling fluid may be guided to flow along one side of the battery cell 30, thereby improving the overall cooling efficiency.

As shown in FIG. 3, when the spacing of the heat transfer members 40 in the region facing the battery cell 30 in the first cooling fluid passage part 40a, that is, the region facing one side of the battery cell 30 is denoted as a', the spacing of the heat transfer members 40 in the region facing the battery cell 30 in the second cooling fluid passage part 40b, that is, the region facing one side of the battery cell 30 is denoted as b', and the spacing of the heat transfer members 40 in the region facing the battery cell 30 in the third cooling fluid passage part 40c, that is, the region facing one side of the battery cell 30 is denoted as c', the relationship a'> b'> c' can be established. As described above, this is intended to relatively adjust the flow speed of a cooling fluid as the cooling fluid flows through each cooling space.

In addition, in the area of each cooling space, by forming the gap between the heat transfer members 40 located near opposite ends of the battery cell 30, or in regions beyond opposite ends of the battery cell 30, with a width e narrower than a', b', and/or c', the flow of a cooling fluid may be naturally concentrated in the direction along one side of the battery cell 30 during the circulation of the cooling fluid.

In the embodiment of FIG. 3, the second cooling fluid passage part 40b may have seven heat transfer members 40, with three of the heat transfer members 40 being positioned centrally, and two pairs of the heat transfer members 40 being positioned at opposite ends of the second cooling fluid passage part 40b. The gap b’ between the three centrally positioned heat transfer members 40 is smaller than the gap a’ between the centrally positioned heat transfer members 40 of the first cooling fluid passage part 40a.

In the same embodiment of FIG. 3, the third cooling fluid passage part 40c may have 10 heat transfer members 40 equally distanced from each other, with the gap c’ between adjacent heat transfer members 40 being smaller than the gap b’ between the three centrally positioned heat transfer members 40 of the second cooling fluid passage part 40b.

As shown in FIG. 4, each of the cooling fluid passage parts 40a, 40b, and 40c, is composed of the plurality of heat transfer members 40, and the diameter of the heat transfer members 40 adjacent each end of the battery cells 30 (e.g., at about each end of the battery cells 30 or in a region beyond each end of the battery cell 30) is formed to be relatively larger than the diameter of the heat transfer member 40 at the center of the cooling fluid passage part, that is, the region facing one side of the battery cell 30.

By configuring the diameter of the heat transfer member 40 relatively larger at each end of the battery cell 30 or in a region beyond each end of the battery cell 30, the flow of a cooling fluid may be concentrated in the direction along one side of the battery cell 30 during the circulation of the cooling fluid. In addition, by adjusting the relative diameters of the heat transfer members 40, the contact area between the heat transfer members 40 and the cooling fluid may be increased, thereby further improving the efficiency of cooling the cooling fluid itself.

By doing so, cooling through contact with the battery cell 30 may be achieved in all directions in which the cooling fluid flows. In addition, through the region where the diameter of the cylindrical heat transfer member 40 is made relatively larger, it is possible to both control the flow direction of the cooling fluid and enhance the cooling efficiency of the fluid itself, thereby also improving the cooling efficiency of the cooling fluid that comes into contact with the battery cell 30.

Likewise in FIG. 4, when the spacing of the heat transfer members 40 in the region facing the battery cell 30 in the first cooling fluid passage part 40a, that is, the region facing one side of the battery cell 30 is denoted as a'', the spacing of the heat transfer members 40 in the region facing the battery cell 30 in the second cooling fluid passage part 40b, that is, the region facing one side of the battery cell 30 is denoted as b'', and the spacing of the heat transfer members 40 in the region facing the battery cell 30 in the third cooling fluid passage part 40c, that is, the region facing one side of the battery cell 30 is denoted as c'', the relationship a''> b''> c'' can be established. As described above, this is intended to relatively adjust the flow speed of a cooling fluid as the cooling fluid flows through each cooling space.

The embodiments of the present disclosure have been described in detail through specific embodiments. These embodiments are not intended to limit the scope of the appended claims. It will be readily apparent to those skilled in the art that various changes and modifications may be made to the disclosed embodiments without departing from the spirit and scope of the present disclosure, and such variations are naturally encompassed within the scope of the appended claims.

What is claimed is:

1. An immersion cooling module comprising:
a housing including an inlet for cooling fluid to flow in and an outlet for cooling fluid to flow out, and in which the cooling fluid is accommodated at a predetermined level to form an upper space;
a cooling chamber coupled to a lower end of the housing, and configured to have a chamber inlet through which the cooling fluid flows in and a chamber outlet through which the cooling fluid is discharged;
battery cells spaced apart from each other and immersed in the cooling fluid; and
cooling fluid passage parts respectively formed in cooling spaces divided by the battery cells, wherein heat transfer members are arranged at predetermined intervals in a direction perpendicular to a flow direction of the cooling fluid,
wherein each of the heat transfer members is formed such that a portion of a first side thereof is accommodated in the cooling chamber and a portion of a second side thereof is exposed to the upper space of the housing.

2. The module of claim 1, wherein the heat transfer members are formed in a cylindrical shape, and
wherein the predetermined intervals of the heat transfer members in the cooling fluid passage parts gradually decrease in a direction of the cooling fluid flow from the inlet toward the outlet of the housing.

3. The module of claim 1, further comprising:
an upper inlet formed on a first side of the upper space of the housing; and
an upper outlet formed on a second side of the upper space of the housing,
wherein as a cooling gas flows from the upper inlet to the upper outlet of the upper space of the housing, a second end of the heat transfer member is cooled.

4. The module of claim 2, wherein the cooling fluid passage parts are formed in spaces partitioned by the battery cells from the inlet of the housing into a first cooling fluid passage part, a second cooling fluid passage part, and a third cooling fluid passage part, and
wherein when a spacing between the heat transfer members in the first cooling fluid passage part is denoted as a,
a spacing between the heat transfer members in the second cooling fluid passage part is denoted as b, and
a spacing between the heat transfer members in the third cooling fluid passage part is denoted as c,
sizes of the spacings satisfy a> b> c.

5. The module of claim 2, wherein each of the cooling fluid passage parts is composed of a plurality of heat transfer members, and
wherein a diameter of the heat transfer member at each end of the cooling fluid passage part is formed to be larger than a diameter of the heat transfer member at a center of the cooling fluid passage part.

6. The module of claim 2, wherein each of the cooling fluid passage parts is composed of a plurality of heat transfer members, and
wherein a spacing between the heat transfer members at each end of the cooling fluid passage part is formed narrower than a spacing between the heat transfer members at a center of the cooling fluid passage part.

7. The module of claim 1, wherein each of the cooling fluid passage parts is formed with a plurality of heat transfer members spaced apart at predetermined intervals, and
wherein a spacing between the heat transfer members arranged on a surface facing one side of each of the battery cells is formed to be wider than a spacing between the heat transfer members arranged on a surface not facing each of the battery cells.

8. The module of claim 1, wherein the chamber inlet of the cooling chamber is provided on a lower surface of the housing adjacent to the inlet of the housing, so that a cooling fluid flowing into the inlet flows into the cooling chamber.

9. An immersion cooling module comprising:
a housing including an inlet for cooling fluid to flow in and an outlet for cooling fluid to flow out;
a cooling chamber coupled to a lower side of the housing, and configured to have a chamber inlet through which the cooling fluid flows from the housing in the cooling chamber and a chamber outlet through which the cooling fluid is discharged, wherein the housing and the cooling chamber provide separate paths for the cooling fluid;
battery cells and cooling fluid passage parts spaced apart from each other in an alternating manner,
wherein the battery cells are immersed in the cooling fluid inside the housing with a portion of each battery cell extending above the cooling fluid to a gas cooling space of the housing;
wherein each cooling fluid passage part includes a plurality of heat transfer members spaced apart from each other at a predetermined gap, and
wherein each of the heat transfer members extends both in the housing and in the cooling chamber.
